(19) United States
(12) Patent Application Publication
(10) Pub. No.: US 2006/0130051 A1
(43) Pub. Date: Jun. 15, 2006

(54) Extensible framework for handling submitted form instance data

(75) Inventors: Alex Sanielevici, Delray Beach, FL (US); Michael L. Taylor, Boca Raton, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/011,717

(22) Filed: Dec. 14, 2004

(51) Int. Cl. G06F 9/44

(52) U.S. Cl. 717/171

(57) ABSTRACT

Within a forms server, a method of handling form instance data can include registering a plurality of handlers with the forms server and receiving the form instance data. The method also can include selecting a handler from the plurality of handlers according to the form instance data and instantiating the selected handler to process the form instance data.

### BACKGROUND

1. Field of the Invention

The present invention relates to the collection and distribution of data over a communication network and, more particularly, to processing data obtained through form-based technology.

2. Description of the Related Art

Forms provide a mechanism through which data can be collected from users. In general, forms are graphical user interfaces that can be presented within a browser or other application for rendering markup language. A form can include one or more fields that can be filled in by a user. The fields of a form can be configured and displayed in any of a variety of different ways including, but not limited to, pull down menus, select lists, check boxes, text fields, or the like. When a user is finished entering information into the form; the information is submitted to a predetermined target destination.

XForms is one variety of online form that is based upon Extensible Markup Language (XML). XForms is an XML application that represents the next generation of forms for the Web. The XForms specification, as promulgated by the World Wide Web Consortium (W3C), seeks to split traditional Extensible HTML (XHTML) forms into three parts: (1) an XForms model, (2) form instance data, and (3) a user interface. This structure separates presentation from content, allows reuse, and provides strong typing. XForms reduce the number of round-trips to the server, promote device independence, and reduce the need for scripting.

XForms is not a free-standing document type, but is intended to be integrated into other markup languages. An XForms form template is designed to collect data from a human operator on a remote computing device, possibly while the device is disconnected from the network. The form template includes the information needed to interact with the user on the remote device and create valid form instance data that can be submitted back to a server. The form instance data is formatted as an XML document and, as such, supports complex hierarchical schemas.

Form-based technology often is used as part of a front-end user interface to a back-end processing system. When using forms, whether XForms or HTML forms, typically the destination of the form data is predetermined. Often, however, it becomes necessary to route collected information to a variety of different destinations. In other cases, it becomes necessary, or convenient, to change the location to which collected form data is ultimately routed. The particular routing requirements for the form data can vary depending upon the particular system with which the forms are to be used and further can change over time as the back-end system evolves.

Conventional form-based systems are unable to accommodate changing routing requirements for form data or provide flexible form data distribution. The handling of form data, once collected, is limited. While some solutions have been proposed, these solutions have not fully addressed the issue. Moreover, proposed solutions have been restricted to HTML forms.

For example, one proposed solution for handling form data has been Web Model/View/Controller (MVC) frameworks. MVC frameworks exist in the context of Web Applications and rely upon HTML forms. Within an MVC framework, a browser sends form data using name/value pairs. Accordingly, such systems do not support more complex hierarchical schemas as are possible when data is submitted as an XML document. Further, as MVC frameworks are based upon HTML forms, form data is sent for only one form page. MVC frameworks are unable to submit data collected during a sequence of multiple form pages.

Another disadvantage of MVC frameworks is that HTML form submission is performed using the HTTP server, which requires the server-side component to understand the parameters specific to the form submission. Thus, the server-side component must understand the received form data in the form of name-value pairs and construct an appropriate XML document that conforms to the schema of the back-end processing system. Only after generating the XML document can the server-side component connect to the back-end system to convey the form data.

It would be beneficial to have a flexible architecture for handling form data while avoiding the disadvantages described above.

### SUMMARY OF THE INVENTION

The present invention provides a solution for processing data obtained through form-based technology. One embodiment of the present invention can include a method of handling form instance data within a forms server. The method can include registering a plurality of handlers with the forms server and receiving form instance data. The method further can include selecting a handler from the plurality of handlers according to the form instance data and instantiating the selected handler to process the form instance data.

Another embodiment of the present invention can include a forms server. The forms server can include a plurality of handlers and means for reading a reference from received form instance data. The forms server also can include means for selecting a handler from the plurality of handlers according to the reference and means for instantiating the selected handler to process the form instance data.

Another embodiment of the present invention can include a machine readable storage being programmed to cause a machine to perform the various steps described herein.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a schematic diagram illustrating a system for handling form data in accordance with one embodiment of the present invention.

FIG. 2 is a schematic diagram illustrating a system framework for handling form data in accordance with another embodiment of the present invention.

FIG. 3 is a flow chart illustrating a method of handling form data in accordance with yet another embodiment of the present invention.

### DETAILED DESCRIPTION OF THE INVENTION

The present invention provides a solution for flexibly handling form data. The present invention provides an extensible infrastructure through which users can contribute handlers to the system. When form data is received, the proper handler can be identified and the responsibility for processing the form data can be delegated to the selected handler. The handler can process the received form data and send it to any of a variety of back-end system using any of a variety of communications protocols and/or channels.

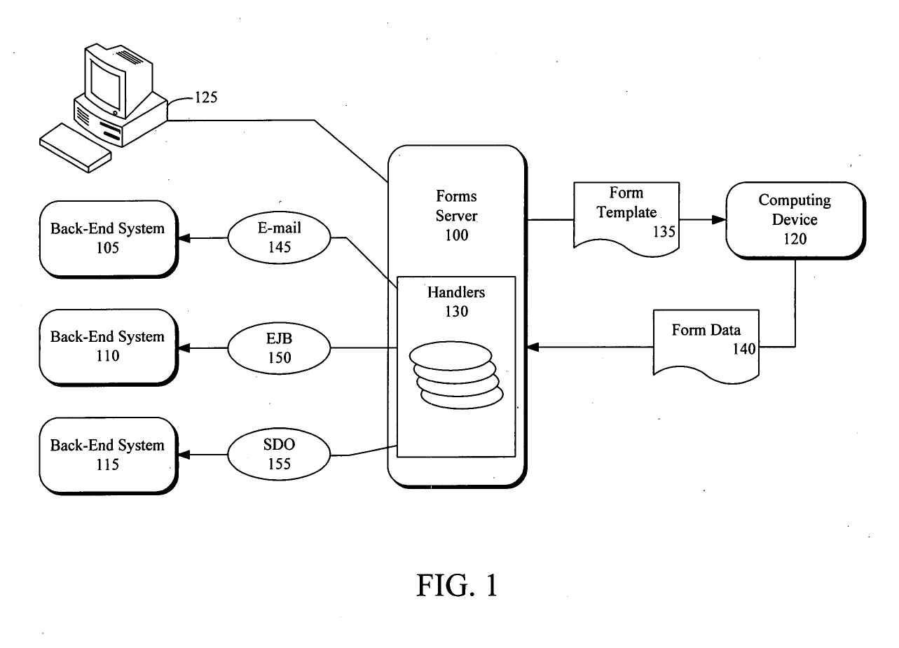

FIG. 1 is a schematic diagram illustrating a system for handling form data in accordance with one embodiment of the present invention. The system can include a. forms server 100, one or more back-end systems 105, 110, and 115, and a computing device 120. An administrative console 125 also can be included.

The forms server 100 can be implemented as one or more computer programs. The forms server 100 can execute within a suitable information processing system, such as a desktop computer system, a server, a portable computer system, or the like. The forms server 100 can include a plurality of handlers 130, also referred to as connectors. The handlers 130 are software objects configured to respond to, and process, received form data within the forms server 100. Each handler can be associated with a particular type of form data and/or form template. Accordingly, when form data is received by the forms server 100, an appropriate handler can be selected from the plurality of handlers 130 to process the received form data.

The forms server 100 can provide a form template 135 to one or more computing devices 120 upon request. In one embodiment of the present invention, the mobile device 120 can be a wireless or mobile computing device such as a mobile phone, a portable computer, or the like. In that case, the form template 135 can be sent to the computing device 120 via a wireless communications link. For example, the forms server 100 and the computing device 120 can communicate over a cellular network, a short-range wireless network, or another suitable wireless communications link.

Once the form template 135 is received by the computing device 120, the form template 135 can be executed. When the user of the computing device 120 has finished entering data into the form template 135, form data 140 can be submitted back to the form server 100. The form data 140 can be provided back to the forms server 100 via the established wireless communications link.

It should be appreciated, however, that the computing device 120 also can be connected to the forms server 100 via a conventional land-based communications network. In that case, the form data 140 can be provided back to the forms server 100 via the established land-based communication link. In any case, the particular type of network over which the forms processor 100 and the computing device 120 communicate is not intended to be a limitation of the present invention.

According to another embodiment, the form template 135 can be an XForms form template. As noted, an XForms form template can include the information needed by the computing device 120 to interact with a user to complete all, or various portions, of the form template 135. Thus, once the user has finished entering data into the form template 135, the form data 140 can be sent back to the forms server 100 as an XML document, referred to as a form instance data.

Upon receiving the form data 140, the forms server 100 can select an appropriate handler to process the received data. The appropriate handler can be selected by identifying a reference included within the form data 140. The reference can specify a particular handler identifier and/or a particular target destination, i.e. back-end system, which also can be associated with a particular handler. The selected handler can route the form data 140, or portions thereof, to any of a variety of back-end systems 105-115 as shown. Thus, the back-end systems receive a structured XML document specifying any data entered into the form template 135 by a user of computing device 120.

As used herein, “back-end system” can refer to one or more computer programs executing within information processing systems that provide business level functions and logic. Typically, a back-end system is a complex, legacy type system that is maintained separately from the user-interface layer. For example, a back-end system can include a database system, a mainframe, or another enterprise level system.

In the example of FIG. 1, back-end system 105 is configured with an electronic mail-based interface. As such, the handler associated with either back-end system 105 or the form data to be sent to back-end system 105 can be configured to send form data 140 via electronic mail 145. Back-end system 110 is configured with an Enterprise JavaBeans ® (EJB®) interface 150. Thus, the handler intended to communicate with back-end system 110 can be configured to send form data 140 through EJB interface 150. Back end system 115 is configured with a Service Data Objects (SDO) interface 155, which is a data programming architecture and application programming interface (API) for the Java™ platform. Accordingly, the handler intended to communicate with back-end system 115 can be configured to send form data using SDO interface 155.

The administrative console 125 provides an interface through which a system administrator or other personnel can administer the forms server 100. For example, through administrative console 125, new forms can be added, new handlers can be added and defined, and existing forms and/or handlers can be edited and/or modified.

It should be appreciated that the back-end systems depicted in FIG. 1 and the interfaces thereto have been provided for purposes of illustration. The particular type of back-end system and interface used are not intended to limit the scope of the present invention. As such, any type of back-end system and/or interface can be incorporated so long as a suitable handler exists to interact with that system and/or interface.

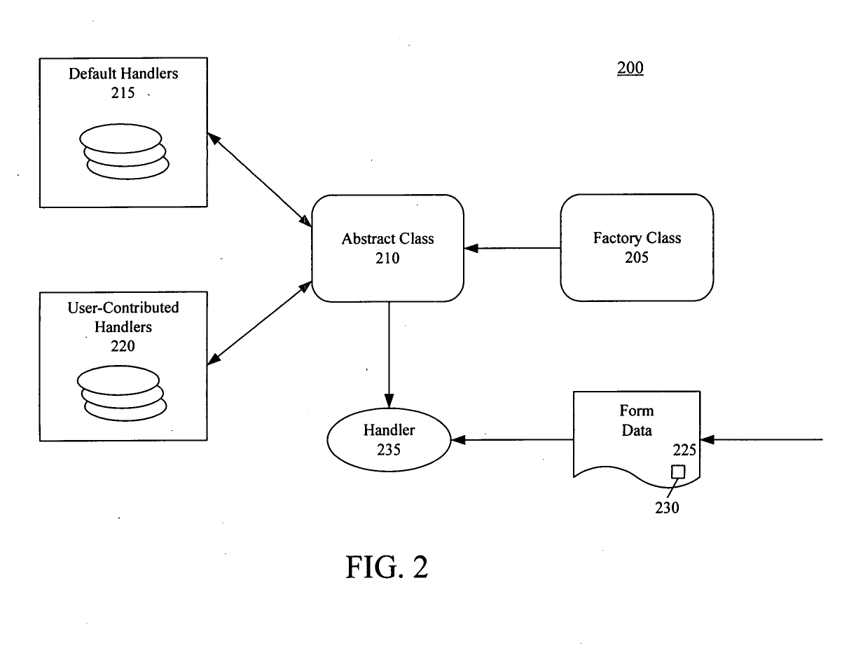

FIG. 2 is a schematic diagram illustrating a framework 200 for handling form data in accordance with another embodiment of the present invention. FIG. 2 illustrates one embodiment of a software framework 200 that can be used with the forms server illustrated in FIG. 1. As shown, the framework 200 can include a factory class 205, an abstract class 210, a plurality of default handlers 215, and a plurality of user-contributed handlers 220.

The present invention provides an architecture through which users can contribute handlers similar to plug-in modules. The default handlers 215 can be handlers that are included within the framework 200 for processing form data. The default handlers 215 can be registered with the framework 200 and can be used, as their name suggests, by default when no other handlers are identified. For example, default handlers 215 can be provided by the owners or administrators of the back-end systems with which the forms server is to communicate. The default handlers 215 can perform functions including, but not limited to, generating formatted e-mail from form submissions, generic Java Database Connectivity (JDBC) persistence from submission data such as mapping XML elements mapped to table columns, and generic Web Service invocation to supply appropriate data from form submissions.

The user-contributed handlers 220 can be handlers that have been added to the framework 200 by users, such as administrators. Each user-contributed handler can be a custom and/or application specific solution. By registering user-contributed handlers 220 with the framework 200, user-contributed handlers 220 can be selected in lieu of default handlers 215 for selected types of form data 225. The user-contributed handlers 220 can perform functions including, but not limited to, back-end specific JDBC persistence from submission data, i.e. XML elements mapped to table columns, routing of a customer portion of submission data to CRM system(s) and the order portion to fulfillment system(s), submission of data to a back-end workflow system, or connectivity to an existing or newly added EJB or other interface.

In operation, form data 225 can be received by framework 200. The form data 225 can be form instance data, such as an XML document generated by an XForms template. The form data 225 can include a reference 230 which specifies a particular handler to be used in processing the form data 225 and routing it to an appropriate target destination, whether a back-end system, a legacy system or application, or an Internet or Web service. For example, the reference 230 can be a submission universal resource identifier (URI) such as “eas2000://expensessystem.ibm.com/”. The reference 230 can specify an identifier of the handler to be used to process form data 225 and a target destination for the form data 225. In this case, the handler identifier is “eas2000” and the target destination is “expensessystem.ibm.com”.

Factory class 205 can identify and instantiate the handler that is registered to process form data 225. The factory class 205 can identify and select a handler from the default handlers 215 or the user-contributed handlers 220 based upon reference 230. That is, the factory class 205 can match the handler identifier of the submission URI in reference 230 with a particular handler in framework 200. In this case the selected handler is handler 235.

The framework 200 can provide an interface, such as “submit(Formlnstance)”, for enforcing the existence of a method to handle the received form data. The abstract class 210 can implement the interface and provide a method referred to as “getlnstance(String)” that can be called by the factory class 205. The method “getInstance(String)” can return an instance of a specific handler named by factory class 205. Since the handler is registered with the framework 200, the handler can be instantiated and its submission method called when matching form data is received for processing.

Because the solution designer is aware of the submission URI and the instance data schema of a given form template, a default handler of form data 225 can be overridden based on information specified in reference 230. By registering user-contributed handlers, form data 225 can be handled or distributed in a way that corresponds with the design and requirements of the target destination. Administrators can register user-contributed handlers that have been configured to perform any necessary functions required by the target destination. This facilitates integration of the form data into the target destination.

The framework 200 disclosed herein places the logic for managing, caching, and pooling handlers within the abstract class 210. The abstract class 210 is hidden from the provider of the handler classes. Thus, a new handler need only extend the abstract class 210, which causes the new handler to be forced by the compiler to implement the application handler interface. Accordingly, the new handler inherits the behavior of the abstract class 210. The new handler will be registered to the framework 200 as being the handler for a given target destination and/or for form data corresponding to a given form template as specified within the submission URI. Accordingly, the framework will manage instantiation, caching and pooling of the handler instances as well as submit forms matching the URI pattern to the user-contributed connector.

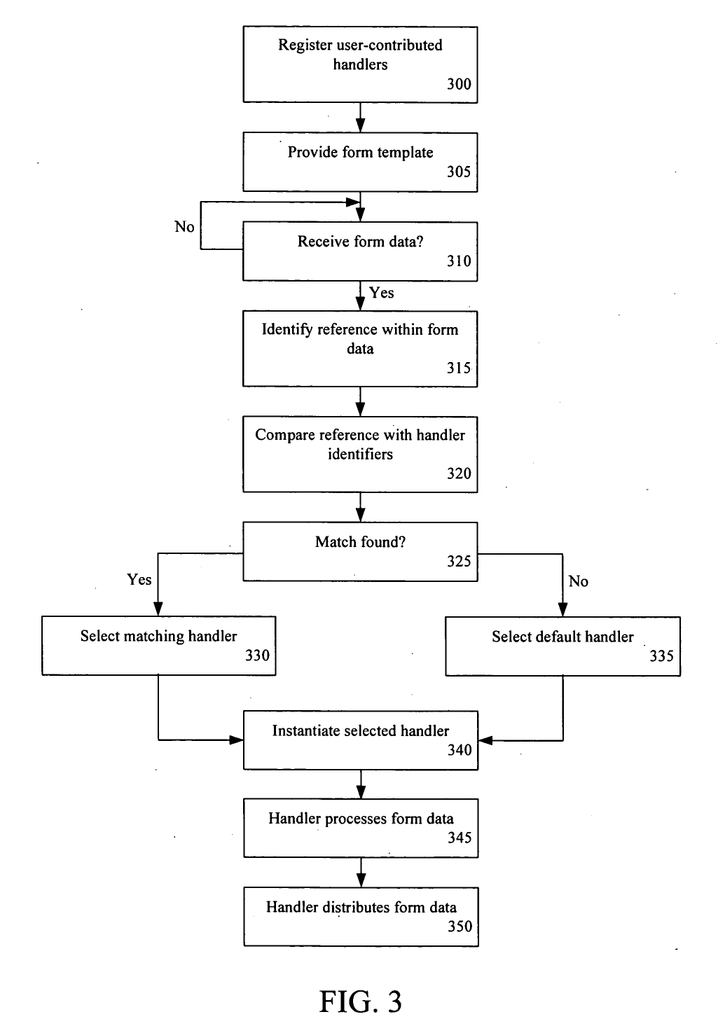

FIG. 3 is a flow chart illustrating a method of handling form data in accordance with yet another embodiment of the present invention. The method can be performed by the system illustrated with reference to FIGS. 2 and 3. Accordingly, the method can begin in step 300 where one or more user-contributed handlers are registered with the forms server framework. As noted, the framework also can include one or more default handlers.

In step 305, the forms server can provide a form template to a remote computing device. As noted, the form template can be provided over a communications link, whether wired or wireless. The remote computing device can be a mobile device, a wireless device, or a stationary device. In step 310, a determination can be made as to whether form data has been received from the computing device. If not, the method can loop back to step 310 to continue monitoring for form data. If form data is received, the method can proceed to step 315.

In step 315, the reference contained within the form data can be identified. As noted, the reference can specify the identity of the handler to be used in processing the form data. The handler specified can be a user-contributed handler or a default handler. In any case, in step 320, the framework can compare the reference with the handler identifiers of the various handlers within the forms server. The reference can be compared with handler identifiers for both user-contributed handlers as well as default handlers.

In step 325, a determination can be made as to whether a handler matching the reference was found. If so, the method can proceed to step 330. If not, the method can continue to step 335. In step 330, the handler corresponding to the matched handler identifier can be selected. In step 335, in the case where no handler identifier is matched with the reference, a default handler can be selected. More particularly, in cases where no handler is found that matches the reference within the form data, the framework can be programmed to select a default handler that can be used to process the received form data.

In step 340, the selected handler can be instantiated. Accordingly, the handler can process the received form data in step 345. As noted, the form data can be form instance data formatted as an XML document. The handler can distribute the form data to one or more destinations in step 350. While the handler can be configured to route the form data, or portions thereof, to one or more different target destinations, at least one of the destinations also can be specified in the reference contained in the form data. The method can repeat as necessary to process additional form data.

It should be appreciated that the selected handler further can send selected portions of the form data to one destination and other portions to other destinations. Such can be the case as the form data can be specified as an XML document having a defined schema.

The inventive arrangements disclosed herein provide a method, system, and apparatus for flexibly handling form data. The present invention provides an extensible architecture through which users can register additional handlers in a modular fashion. By using a framework as disclosed herein, a new handler need only extend the abstract class, which causes the new handler to implement the application handler interface. The new handler will be registered to the framework as being the handler for a given target destination as specified within the reference within received form data.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, program, software, or software application, in the present context, means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. Within a forms server, a method of handling form instance data comprising:
registering a plurality of handlers with the forms server;
receiving form instance data;
selecting a handler from the plurality of handlers according to the form instance data; and
instantiating the selected handler to process the form instance data.

2. The method of claim 1, said instantiating step comprising calling a submission method of the selected handler.

3. The method of claim 1, wherein the selected handler is a user-contributed handler.

4. The method of claim 3, said selecting step comprising:
reading, from the form instance data, a reference specifying a target handler;
comparing the reference with the plurality of handlers; and
if the target handler is found within the plurality of handlers, using the target handler as the selected handler.

5. The method of claim 4, wherein the plurality of handlers includes a default handler for the form instance data, said instantiating step comprising processing the form instance data using the user-contributed handler in lieu of the default handler.

6. The method of claim 1, wherein the plurality of handlers includes a default handler for the form instance data, said selecting step comprising:
reading, from the form instance data, a reference specifying a target handler;
comparing the reference with the plurality of handlers; and if the target handler is not found within the plurality of handlers, using a default handler as the selected handler.

7. The method of claim 1, said instantiating step further comprising invoking a method of an abstract class to return an instance of the selected handler.

8. The method of claim 7, wherein the selected handler inherits behavior of the abstract class.

9. The method of claim 7, wherein the method of the abstract class is invoked by a factory class.

10. A machine readable storage, having stored thereon a computer program having a plurality of code sections executable by a machine for causing the machine to perform the steps of:
registering a plurality of handlers with a forms server;
receiving form instance data;
selecting a handler from the plurality of handlers according to the form instance data; and
instantiating the selected handler to process the form instance data.

11. The machine readable storage of claim 10, said instantiating step comprising calling a submission method of the selected handler.

12. The machine readable storage of claim 10, wherein the selected handler is a user-contributed handler.

13. The machine readable storage of claim 12, said selecting step comprising:
reading, from the form instance data, a reference specifying a target handler;
comparing the reference with the plurality of handlers; and
if the target handler is found within the plurality of handlers, using the target handler as the selected handler.

14. The machine readable storage of claim 13, wherein the plurality of handlers includes a default handler for the form instance data, said instantiating step comprising processing the form instance data using the user-contributed handler in lieu of the default handler.

15. The machine readable storage of claim 10, wherein the plurality of handlers includes a default handler for the form instance data, said selecting step comprising:
reading, from the form instance data, a reference specifying a target handler;
comparing the reference with the plurality of handlers; and
if the target handler is not found within the plurality of handlers, using a default handler as the selected handler.

16. The machine readable storage of claim 10, said instantiating step further comprising invoking a method of an abstract class to return an instance of the selected handler.

17. The machine readable storage of claim 16, wherein the selected handler inherits behavior of the abstract class.

18. The machine readable storage of claim 16, wherein the method of the abstract class is invoked by a factory class.

19. A forms server comprising:
a plurality of handlers;
means for reading a reference within received form instance data;
means for selecting a handler from the plurality of handlers according to the reference; and
means for instantiating the selected handler to process the form instance data.

20. The forms server of claim 19, further comprising means for selecting a default handler from the plurality of handlers if the handler identified by the received form instance data is not found.
